(19) United States
(12) Patent Application Publication
(10) Pub. No.: US 2024/0219551 A1
(43) Pub. Date: Jul. 4, 2024

(54) RADAR APPARATUS, SIGNAL PROCESSING METHOD, AND PROGRAM

(71) Applicant: SONY SEMICONDUCTOR SOLUTIONS CORPORATION, KANAGAWA (JP)

(72) Inventor: RYO SASAKI, KANAGAWA (JP)

(21) Appl. No.: 18/556,876

(22) PCT Filed: Feb. 16, 2022
(86) PCT No.: PCT/JP2022/006158

§ 371 Date: Oct. 23, 2023

(30) Foreign Application Priority Data
May 12, 2021 (JP) 2021-080992

(51) Int. Cl. G01S 13/34; G01S 7/35; G01S 13/931

(52) U.S. Cl. CPC G01S 13/34; G01S 7/354; G01S 13/931

(57) ABSTRACT

A radar apparatus according to an embodiment of the present technology includes a first extraction unit, a second extraction unit, and a peak detection unit. The first extraction unit sets a first threshold by performing constant false alarm rate (CFAR) processing on a frequency spectrum, the frequency spectrum being generated on the basis of a reception signal obtained by receiving a reflected wave obtained by reflection of a radar wave, and extracts a noise signal from signals smaller than the first threshold in the frequency spectrum. The second extraction unit sets a second threshold on the basis of the noise signal and extracts, as a detection signal, a signal larger than the second threshold in the frequency spectrum. The peak detection unit detects a peak of the detection signal.

### TECHNICAL FIELD

The present technology relates to a radar apparatus that can be mounted on a vehicle or the like, a signal processing method, and a program.

### BACKGROUND ART

Patent Literature 1 discloses a radar apparatus that can suppress erroneous detection of an internal reflection signal of a vehicle. In such a radar apparatus, constant false alarm rate (CFAR) detection is performed as a method of detecting a threshold on the basis of noise power.

### CITATION LIST

### Patent Literature

Patent Literature 1: Japanese Patent Application Laid-open No. 2019-197027

### DISCLOSURE OF INVENTION

### Technical Problem

In a radar apparatus mounted on a vehicle or the like, there is a need for a technique for improving detection accuracy of a target object.

In view of the circumstances as described above, it is an object of the present technology to provide a radar apparatus, a signal processing method, and a program that are capable of improving detection accuracy of a target object.

### Solution to Problem

In order to achieve the above object, a radar apparatus according to an embodiment of the present technology includes a first extraction unit, a second extraction unit, and a peak detection unit.

The first extraction unit sets a first threshold by performing constant false alarm rate (CFAR) processing on a frequency spectrum, the frequency spectrum being generated on the basis of a reception signal obtained by receiving a reflected wave obtained by reflection of a radar wave, and extracts a noise signal from signals smaller than the first threshold in the frequency spectrum.

The second extraction unit sets a second threshold on the basis of the noise signal and extracts, as a detection signal, a signal larger than the second threshold in the frequency spectrum.

The peak detection unit detects a peak of the detection signal.

In such a radar apparatus, the CFAR processing is performed on the frequency spectrum to set the first threshold, and the noise signal is extracted from signals smaller than the first threshold in the frequency spectrum. Further, the second threshold is set on the basis of the noise signal, and a signal larger than the second threshold in the frequency spectrum is extracted as a detection signal. Detecting a peak of the detection signal makes it possible to improve detection accuracy of a target object.

The first extraction unit may extract, as the noise signal, a signal smaller than the first threshold or some signals of the signals smaller than the first threshold.

The first extraction unit may extract, as the noise signal, a signal included in a predetermined range among the signals smaller than the first threshold.

The first extraction unit may extract, as the noise signal, a signal other than a signal corresponding to a reflected wave from a stationary object among the signals smaller than the first threshold.

The second extraction unit may calculate a noise floor on the basis of the noise signal and may set, as the second threshold, a value larger than the calculated noise floor.

The second extraction unit may calculate, as the noise floor, an average value, a variance value, or a standard deviation of the noise signal.

The second extraction unit may set, as the second threshold, a value obtained by multiplying the noise floor by a predetermined coefficient or a value obtained by adding a predetermined constant to the noise floor.

The radar apparatus may further include a transmission and reception unit that emits the radar wave by using a frequency modulated continuous wave (FMCW) signal obtained by frequency-modulating a continuous wave as a transmission signal, and generates a beat signal on the basis of the reception signal and the transmission signal. In this case, the first extraction unit may acquire, as the frequency spectrum, a frequency spectrum related to a distance that is generated by performing Fourier transform in a distance direction on the beat signal.

The radar apparatus may further include a target object information generation unit that detects a target object existing in a vicinity on the basis of a result of the detection by the peak detection unit.

The radar apparatus may be configured to be mounted on a mobile object. In this case, the first extraction unit may extract, as the noise signal, a signal other than a signal corresponding to a reflected wave from a stationary object among the signals smaller than the first threshold, on the basis of a speed of the mobile object and a frequency spectrum related to a relative speed that is generated by performing Fourier transform in a relative speed direction on the frequency spectrum related to the distance.

The radar apparatus may further include a transmission and reception unit that emits the radar wave by using a frequency modulated continuous wave (FMCW) signal obtained by frequency-modulating a continuous wave as a transmission signal, and generates a beat signal on the basis of the reception signal and the transmission signal. In this case, the first extraction unit may acquire, as the frequency spectrum, a frequency spectrum related to a relative speed that is generated by performing Fourier transform in a relative speed direction on a frequency spectrum related to a distance that is generated by performing Fourier transform in a distance direction on the beat signal.

A signal processing method according to an embodiment of the present technology is an information processing method executed by a computer system, the method including: setting a first threshold by performing constant false alarm rate (CFAR) processing on a frequency spectrum, the frequency spectrum being generated on the basis of a reception signal obtained by receiving a reflected wave obtained by reflection of a radar wave, and extracting a noise signal from signals smaller than the first threshold in the frequency spectrum; setting a second threshold on the basis of the noise signal and extracting, as a detection signal, a signal larger than the second threshold in the frequency spectrum; and detecting a peak of the detection signal.

A program according to an embodiment of the present technology causes a computer system to execute the steps of: setting a first threshold by performing constant false alarm rate (CFAR) processing on a frequency spectrum, the frequency spectrum being generated on the basis of a reception signal obtained by receiving a reflected wave obtained by reflection of a radar wave, and extracting a noise signal from signals smaller than the first threshold in the frequency spectrum; setting a second threshold on the basis of the noise signal and extracting, as a detection signal, a signal larger than the second threshold in the frequency spectrum; and detecting a peak of the detection signal.

### BRIEF DESCRIPTION OF DRAWINGS

FIG. 1 is a block diagram showing a configuration example of a vehicle control system.

FIG. 2 is a view showing an example of sensing regions.

FIG. 3 is a schematic view showing a configuration example of a radar apparatus.

FIG. 4 is a schematic view for describing a radar wave transmitted from a transmission antenna.

FIG. 5 is a flowchart showing an example of a signal processing method.

FIG. 6 is a graph showing examples of a distance spectrum obtained when the radar apparatus performs measurement.

FIG. 7 is a graph showing a CFAR threshold that is set for the distance spectrum.

FIG. 8 is a graph showing a noise threshold that is set for the distance spectrum.

FIG. 9 is a graph showing examples of a distance spectrum corresponding to an azimuth angle (Azimuth).

FIG. 10 is a graph showing an example of a two-dimensional spectrum having two axes of a distance (Range) and a relative speed (Speed).

### Mode(s) for Carrying Out the Invention

Hereinafter, an embodiment according to the present technology will be described with reference to the drawings.

### Configuration Example Of Vehicle Control System

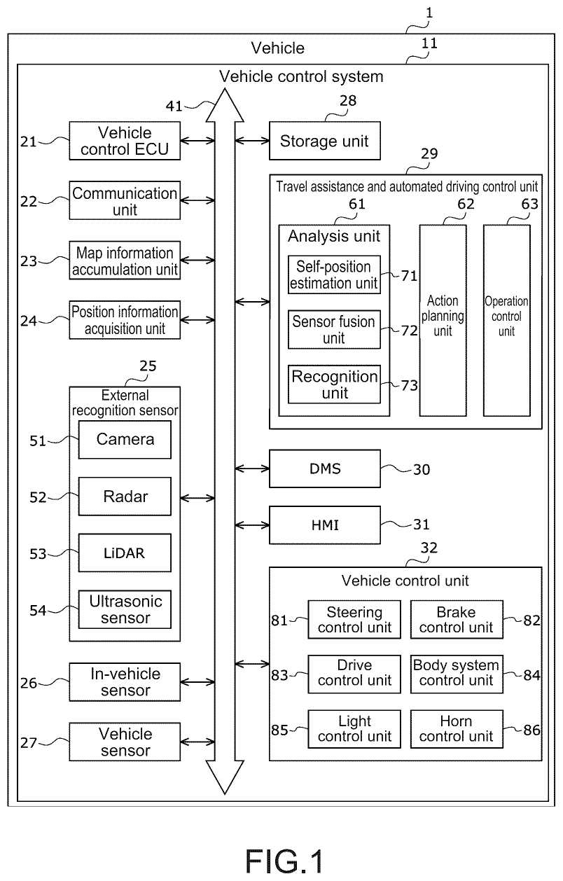

FIG. 1 is a block diagram showing a configuration example of a vehicle control system 11 that is an example of a mobile apparatus control system to which the present technology is applied.

The vehicle control system 11 is provided to a vehicle 1 and performs processing related to travel assistance and automated driving of the vehicle 1.

The vehicle control system 11 includes a vehicle control electronic control unit (ECU) 21, a communication unit 22, a map information accumulation unit 23, a position information acquisition unit 24, an external recognition sensor 25, an in-vehicle sensor 26, a vehicle sensor 27, a storage unit 28, a travel assistance and automated driving control unit 29, a driver monitoring system (DMS) 30, a human machine interface (HMI) 31, and a vehicle control unit 32.

The vehicle control ECU 21, the communication unit 22, the map information accumulation unit 23, the position information acquisition unit 24, the external recognition sensor 25, the in-vehicle sensor 26, the vehicle sensor 27, the storage unit 28, the travel assistance and automated driving control unit 29, the driver monitoring system (DMS) 30, the human machine interface (HMI) 31, and the vehicle control unit 32 are communicably connected to each other via a communication network 41.

The communication network 41 includes, for example, an in-vehicle communication network, a bus, or the like conforming to digital bidirectional communication standards such as a controller area network (CAN), a local interconnect network (LIN), a local area network (LAN), FlexRay (registered trademark), and Ethernet (registered trademark).

The communication network 41 may be selectively used depending on the type of data to be transmitted. For example, CAN may be applied to data related to vehicle control, and the Ethernet may be applied to large-capacity data. Note that the units of the vehicle control system 11 are directly connected to each other using wireless communication assuming relatively short-distance communication, such as near field communication (NFC) and Bluetooth (registered trademark), without the communication network 41 in some cases.

Note that the description of the communication network 41 is hereinafter omitted when each unit of the vehicle control system 11 performs communication via the communication network 41. For example, when the vehicle control ECU 21 and the communication unit 22 perform communication via the communication network 41, it is simply described that the vehicle control ECU 21 and the communication unit 22 perform communication.

The vehicle control ECU 21 includes, for example, various processors such as a central processing unit (CPU) and a micro processing unit (MPU). The vehicle control ECU 21 controls all or a part of the functions of the vehicle control system 11.

The communication unit 22 performs communication with various devices inside and outside the vehicle, other vehicles, servers, base stations, and the like, and transmits and receives various types of data. At that time, the communication unit 22 can perform communication using a plurality of communication methods.

Communication with the outside of the vehicle, which can be performed by the communication unit 22, will be schematically described.

The communication unit 22 performs communication with a server on an external network (hereinafter, referred to as external server) or the like via a base station or an access point by, for example, a wireless communication method such as a fifth-generation mobile communication system (5G), long term evolution (LTE), or dedicated short range communications (DSRC).

The external network through which the communication unit 22 performs communication is, for example, the Internet, a cloud network, or a network specific to a business operator. The communication method performed by the communication unit 22 for the external network is not particularly limited as long as the communication method is a wireless communication method capable of performing digital bidirectional communication at a predetermined communication speed or higher and at a predetermined distance or more.

Further, for example, the communication unit 22 can perform communication with a terminal located in the vicinity of the own vehicle by using a peer-to-peer (P2P) technology. The terminal located in the vicinity of the own vehicle is, for example, a terminal that is mounted on a mobile object moving at a relatively low speed, such as a pedestrian or a bicycle, a terminal fixed in position in a store or the like, or a machine-type communication (MTC) terminal.

In addition, the communication unit 22 can also perform V2X communication. The V2X communication refers to, for example, communication between the own vehicle and others, such as vehicle-to-vehicle communication with another vehicle, vehicle-to-infrastructure communication with a roadside device or the like, vehicle-to-home communication with a home, and vehicle-to-pedestrian communication with a terminal or the like carried by a pedestrian.

The communication unit 22 can receive, for example, a program for updating software for controlling an operation of the vehicle control system 11 from the outside (Over The Air).

In addition, the communication unit 22 can receive information such as map information, traffic information, or information of the surroundings of the vehicle 1 from the outside. Further, for example, the communication unit 22 can transmit information regarding the vehicle 1, information of the surroundings of the vehicle 1, or the like to the outside.

The information regarding the vehicle 1, which is transmitted by the communication unit 22 to the outside, includes, for example, data indicating a state of the vehicle 1 or a recognition result provided by a recognition unit 73. Further, for example, the communication unit 22 performs communication corresponding to a vehicle emergency call system such as eCall.

For example, the communication unit 22 receives an electromagnetic wave transmitted by a road traffic information communication system (vehicle information and communication system (VICS) (registered trademark)) such as a radio beacon, an optical beacon, or FM multiplex broadcasting.

Communication with the inside of the vehicle, which can be performed by the communication unit 22, will be schematically described.

The communication unit 22 can perform communication with each in-vehicle device by using, for example, wireless communication. The communication unit 22 can perform wireless communication with the in-vehicle device by, for example, a communication method capable of performing digital bidirectional communication at a predetermined communication speed or higher through wireless communication, such as a wireless LAN, Bluetooth, NFC, or wireless USB (WUSB).

The communication unit 22 is not limited to the above and can also perform communication with each in-vehicle device using wired communication. For example, the communication unit 22 can perform communication with each in-vehicle device through wired communication via a cable connected to a connection terminal (not shown).

The communication unit 22 can perform communication with each in-vehicle device by, for example, a communication method capable of performing digital bidirectional communication at a predetermined communication speed or higher through wired communication, such as a universal serial bus (USB), a high-definition multimedia interface (HDMI) (registered trademark), or a mobile high-definition link (MHL).

Here, the in-vehicle device refers to, for example, a device that is not connected to the communication network 41 in the vehicle. Examples of the in-vehicle devices assumed include a mobile device or wearable device carried by a passenger such as a driver, and an information device that is brought into the vehicle and temporarily installed in the vehicle.

The map information accumulation unit 23 accumulates one or both of a map acquired from the outside and a map created by the vehicle 1. For example, the map information accumulation unit 23 accumulates a three-dimensional high-accuracy map, a global map that is lower in accuracy than the high-accuracy map and covers a wide area, or the like.

The high-accuracy map is, for example, a dynamic map, a point cloud map, a vector map, or the like. The dynamic map is, for example, a map including four layers of dynamic information, quasi-dynamic information, quasi-static information, and static information, and is provided from the external server or the like to the vehicle 1.

The point cloud map is a map configured by point cloud (point cloud data). The vector map is, for example, a map in which traffic information such as a position of a lane or a traffic light is associated with a point cloud map and adapted to an advanced driver assistance system (ADAS) or autonomous driving (AD).

For example, the point cloud map and the vector map may be provided from the external server or the like, or may be created by the vehicle 1 as maps for performing matching with a local map, which will be described later, on the basis of a sensing result provided by a camera 51, a radar apparatus 52, a LiDAR 53, or the like and then accumulated in the map information accumulation unit 23.

Further, if a high-accuracy map is provided from the external server or the like, in order to reduce the communication capacity, for example, map data of several hundred meters square, regarding a planned path through which the vehicle 1 will travel, is acquired from the external server or the like.

The position information acquisition unit 24 receives a global navigation satellite system (GNSS) signal from a GNSS satellite and acquires position information of the vehicle 1. The acquired position information is supplied to the travel assistance and automated driving control unit 29. Note that the position information acquisition unit 24 is not limited to the method using a GNSS signal, and may acquire position information by using a beacon, for example.

The external recognition sensor 25 includes various sensors used to recognize a situation outside the vehicle 1, and supplies sensor data from the sensors to the units of the vehicle control system 11. The type and number of sensors included in the external recognition sensor 25 are discretionally set.

For example, the external recognition sensor 25 includes a camera 51, a radar apparatus 52, a LiDAR (Light Detection and Ranging, Laser Imaging Detection and Ranging) 53, and an ultrasonic sensor 54. The external recognition sensor 25 is not limited to the above, and may be configured to include one or more types of sensors among the camera 51, the radar apparatus 52, the LiDAR 53, and the ultrasonic sensor 54.

The number of cameras 51, radar apparatuses 52, LiDARs 53, and ultrasonic sensors 54 is not particularly limited as long as they can be practically installed in the vehicle 1. Further, the type of sensors included in the external recognition sensor 25 is not limited to the above example, and the external recognition sensor 25 may include other types of sensors. Examples of sensing regions of the respective sensors included in the external recognition sensor 25 will be described later.

Note that an imaging method of the camera 51 is not particularly limited. For example, cameras of various imaging methods, such as a time-of-flight (ToF) camera, a stereo camera, a monocular camera, and an infrared ray camera using imaging methods capable of ranging, can be applied to the camera 51 as necessary. The camera 51 is not limited to the above and may be a camera for simply acquiring a captured image irrespective of ranging.

Further, for example, the external recognition sensor 25 can include an environment sensor for detecting an environment with respect to the vehicle 1. The environment sensor is a sensor for detecting an environment such as weather, an atmospheric phenomenon, or brightness, and can include various sensors such as a raindrop sensor, a fog sensor, a sunshine sensor, a snow sensor, and an illuminance sensor.

In addition, for example, the external recognition sensor 25 includes a microphone used for detecting sound around the vehicle 1 or a position of a sound source, for example.

The in-vehicle sensor 26 includes various sensors for detecting information of the inside of the vehicle, and supplies sensor data from the sensors to the units of the vehicle control system 11. The type or number of various sensors included in the in-vehicle sensor 26 is not particularly limited as long as they can be practically installed in the vehicle 1.

For example, the in-vehicle sensor 26 can include one or more types of sensors among a camera, a radar apparatus, a seating sensor, a steering wheel sensor, a microphone, and a biometric sensor.

As the camera included in the in-vehicle sensor 26, for example, cameras of various imaging methods capable of ranging, such as a time-of-flight (ToF) camera, a stereo camera, a monocular camera, and an infrared ray camera, can be used. The camera included in the in-vehicle sensor 26 is not limited to the above and may be a camera for simply acquiring a captured image irrespective of ranging.

The biometric sensor included in the in-vehicle sensor 26 is provided to, for example, a seat or a steering wheel and detects various types of biometric information of a passenger such as a driver.

The vehicle sensor 27 includes various sensors for detecting a state of the vehicle 1 and supplies sensor data obtained from the sensors to the units of the vehicle control system 11. The type or number of various sensors included in the vehicle sensor 27 is not particularly limited as long as they can be practically installed in the vehicle 1.

For example, the vehicle sensor 27 includes a speed sensor, an acceleration sensor, an angular velocity sensor (gyro sensor), and an inertial measurement unit (IMU) that integrates those above sensors.

For example, the vehicle sensor 27 includes a steering angle sensor that detects a steering angle of a steering wheel, a yaw rate sensor, an accelerator sensor that detects the amount of operation of an accelerator pedal, and a brake sensor that detects the amount of operation of a brake pedal.

For example, the vehicle sensor 27 includes a rotation sensor that detects revolutions per minute of an engine or a motor, a pneumatic sensor that detects a tire pressure, a slip rate sensor that detects a slip rate of a tire, and a wheel speed sensor that detects a rotation speed of a wheel.

For example, the vehicle sensor 27 includes a battery sensor that detects a remaining battery level and a temperature of a battery, and an impact sensor that detects an impact from the outside.

The storage unit 28 includes at least one of a non-volatile storage medium or a volatile storage medium, and stores data and a program. The storage unit 28 is used as, for example, an electrically erasable programmable read only memory (EEPROM) and a random access memory (RAM). As the storage medium, a magnetic storage device such as a hard disc drive (HDD), a semiconductor storage device, an optical storage device, and a magneto-optical storage device can be applied.

The storage unit 28 stores various programs or data that are used by the units of the vehicle control system 11. For example, the storage unit 28 includes an event data recorder (EDR) or a data storage system for automated driving (DSSAD) and stores information of the vehicle 1 before and after an event such as an accident or information acquired by the in-vehicle sensor 26.

The travel assistance and automated driving control unit 29 performs control of travel assistance and automated driving of the vehicle 1. For example, the travel assistance and automated driving control unit 29 includes an analysis unit 61, an action planning unit 62, and an operation control unit 63.

The analysis unit 61 performs analysis processing of the vehicle 1 and a surrounding situation. The analysis unit 61 includes a self-position estimation unit 71, a sensor fusion unit 72, and a recognition unit 73.

The self-position estimation unit 71 estimates a self-position of the vehicle 1 on the basis of the sensor data of the external recognition sensor 25 and a high-accuracy map accumulated in the map information accumulation unit 23.

For example, the self-position estimation unit 71 generates a local map on the basis of the sensor data from the external recognition sensor 25 and estimates a self-position of the vehicle 1 by matching the local map with the high-accuracy map. The position of the vehicle 1 is based on, for example, the center of a rear wheel pair axle.

The local map is, for example, a three-dimensional high-accuracy map created using a technology such as simultaneous localization and mapping (SLAM), an occupancy grid map, or the like.

The three-dimensional high-accuracy map is, for example, the above-mentioned point cloud map.

The occupancy grid map is a map that is obtained by dividing a three-dimensional or two-dimensional space around the vehicle 1 into grids having a predetermined size and indicates the occupied state of an object in units of grids. The occupied state of an object is indicated by, for example, the presence or absence of the object or a probability of presence.

The local map is also used in, for example, detection processing and recognition processing of a situation outside the vehicle 1 by the recognition unit 73.

Note that the self-position estimation unit 71 may estimate a self-position of the vehicle 1 on the basis of the position information acquired by the position information acquisition unit 24 and the sensor data from the vehicle sensor 27.

The sensor fusion unit 72 performs sensor fusion processing for obtaining new information by combining a plurality of different types of sensor data (for example, image data supplied from the camera 51 and sensor data supplied from the radar apparatus 52). Examples of the method of combining different types of sensor data include integration, fusion, and association.

The recognition unit 73 performs detection processing for detecting a situation outside the vehicle 1 and recognition processing for recognizing a situation outside the vehicle 1.

For example, the recognition unit 73 performs detection processing and recognition processing of a situation outside the vehicle 1 on the basis of information from the external recognition sensor 25, information from the self-position estimation unit 71, information from the sensor fusion unit 72, and the like.

Specifically, for example, the recognition unit 73 performs detection processing, recognition processing, and the like of an object around the vehicle 1. The detection processing of an object is, for example, processing of detecting the presence or absence, size, shape, position, and motion of an object.

The recognition processing of an object is, for example, processing of recognizing an attribute such as a type of an object or identifying a specific object. Note that the detection processing and the recognition processing are not necessarily clearly separated from each other and overlap with each other in some cases.

For example, the recognition unit 73 detects an object around the vehicle 1 by performing clustering for classifying a point cloud based on the sensor data, which is provided by the radar apparatus 52, the LiDAR 53, or the like, into clusters of point cloud. Thus, the presence or absence, size, shape, and position of the object around the vehicle 1 are detected.

For example, the recognition unit 73 performs tracking that follows the motion of the clusters of point cloud classified by clustering, to detect the motion of the object around the vehicle 1. Thus, the speed and the traveling direction (movement vector) of the object around the vehicle 1 are detected.

For example, the recognition unit 73 detects or recognizes a vehicle, a person, a bicycle, an obstacle, a structure, a road, a traffic light, a traffic sign, a road sign, or the like on the basis of the image data supplied from the camera 51. Further, the recognition unit 73 may recognize the type of the object around the vehicle 1 by performing recognition processing such as semantic segmentation.

For example, the recognition unit 73 can perform recognition processing of traffic rules around the vehicle 1 on the basis of the map accumulated in the map information accumulation unit 23, an estimation result of the self-position by the self-position estimation unit 71, and a recognition result of the object around the vehicle 1 by the recognition unit 73. By such processing, the recognition unit 73 can recognize a position and a state of a traffic light, contents of a traffic sign and a road sign, contents of traffic restriction, a travelable lane, and the like.

For example, the recognition unit 73 can perform recognition processing of the environment around the vehicle 1. As the surrounding environment to be recognized by the recognition unit 73, weather, temperature, humidity, brightness, a state of a road surface, and the like are assumed.

The action planning unit 62 creates an action plan of the vehicle 1. For example, the action planning unit 62 creates an action plan by performing processing of path planning and path tracking.

Note that the path planning (global path planning) refers to processing of planning a rough path from the start to the goal. Such path planning also includes processing called trajectory planning, which performs trajectory generation (local path planning) capable of safe and smooth traveling in the vicinity of the vehicle 1 in consideration of motion characteristics of the vehicle 1 in the planned path.

The path tracking is processing of planning an operation for safe and smooth traveling on a path planned by the path planning within a planned time. The action planning unit 62 can calculate a target speed and a target angular velocity of the vehicle 1 on the basis of, for example, a processing result of the path tracking.

The operation control unit 63 controls an operation of the vehicle 1 in order to implement the action plan created by the action planning unit 62.

For example, the operation control unit 63 controls a steering control unit 81, a brake control unit 82, and a drive control unit 83, which are included in the vehicle control unit 32 to be described later, to perform acceleration/deceleration control and direction control such that the vehicle 1 travels in a trajectory calculated by the trajectory planning.

For example, the operation control unit 63 performs cooperative control for the purpose of implementing the functions of ADAS, such as collision avoidance or shock relaxation, following travel, vehicle speed maintaining travel, collision warning of the own vehicle, and lane departure warning of the own vehicle. For example, the operation control unit 63 performs cooperative control for the purpose of automated driving for traveling in an automated manner regardless of an operation of the driver.

The DMS 30 performs authentication processing of a driver, recognition processing of a state of the driver, or the like on the basis of the sensor data from the in-vehicle sensor 26, input data that is input to the HMI 31 to be described later, or the like. As the state of the driver to be recognized, for example, a health condition, a degree of consciousness, a degree of concentration, a degree of fatigue, a gaze direction, a degree of inebriation, a driving operation, a posture, and the like are assumed.

Note that the DMS 30 may perform authentication processing of a passenger other than the driver and recognition processing of a state of the passenger. Further, for example, the DMS 30 may perform recognition processing of a situation inside the vehicle on the basis of the sensor data from the in-vehicle sensor 26. As the situation inside the vehicle to be recognized, for example, temperature, humidity, brightness, smell, and the like are assumed.

The HMI 31 inputs various types of data, instructions, or the like, and presents various types of data to the driver or the like.

The input of data by the HMI 31 will be schematically described.

The HMI 31 includes an input device used for a person to input data. The HMI 31 generates an input signal on the basis of the data, instruction, or the like input by the input device, and supplies the input signal to the units of the vehicle control system 11.

The HMI 31 includes an operation element such as a touch panel, a button, a switch, or a lever as the input device. The HMI 31 is not limited to the above, and may further include an input device capable of inputting information by a method other than a manual operation, e.g., voice or gesture.

In addition, the HMI 31 may also use, for example, a remote control apparatus using infrared rays or radio waves, or an externally connected device such as a mobile device or wearable device corresponding to an operation of the vehicle control system 11, as an input device.

The presentation of the data by the HMI 31 will be schematically described.

The HMI 31 generates visual information, auditory information, and tactile information for the passenger or the outside of the vehicle. Further, the HMI 31 performs output control for controlling output of each piece of generated information, contents of output, an output timing, an output method, and the like.

The HMI 31 generates and outputs, for example, information indicated by images and light, such as an operation screen, display of the state of the vehicle 1, display of a warning, or a monitor image indicating a situation of the surroundings of the vehicle 1, as the visual information. Further, the HMI 31 generates and outputs, for example, information indicated by sounds, such as a voice guidance, a warning sound, or a warning message, as the auditory information.

In addition, the HMI 31 generates and outputs, for example, information given to the sense of touch of the passenger by force, vibration, motion, or the like, as the tactile information.

As an output device from which the HMI 31 outputs visual information, for example, a display apparatus that presents visual information by displaying an image by itself or a projector apparatus that presents visual information by projecting an image can be applied.

Note that the display apparatus may be an apparatus that displays visual information within the field of view of a passenger, such as a head-up display, a transmissive display, or a wearable device having an augmented reality (AR) function, in addition to a display apparatus including a normal display.

Further, in the HMI 31, a display device included in a navigation apparatus, an instrument panel, a camera monitoring system (CMS), an electronic mirror, a lamp, or the like provided in the vehicle 1 can also be used as an output device that outputs the visual information.

As an output device from which the HMI 31 outputs the auditory information, for example, an audio speaker, a headphone, or an earphone can be applied.

As an output device from the HMI 31 outputs the tactile information, for example, a haptic element using a haptic technology can be applied. The haptic element is provided at, for example, a portion with which a passenger of the vehicle 1 comes into contact, such as a steering wheel or a seat.

The vehicle control unit 32 controls each unit of the vehicle 1. The vehicle control unit 32 includes the steering control unit 81, the brake control unit 82, the drive control unit 83, a body system control unit 84, a light control unit 85, and a horn control unit 86.

The steering control unit 81 detects and controls a state of a steering system of the vehicle 1, for example. The steering system includes, for example, a steering mechanism including a steering wheel and the like, an electric power steering, and the like.

The steering control unit 81 includes, for example, a steering ECU that controls the steering system, an actuator that drives the steering system, and the like.

The brake control unit 82 detects and controls a state of a brake system of the vehicle 1, for example. The brake system includes, for example, a brake mechanism including a brake pedal and the like, an antilock brake system (ABS), a regenerative brake mechanism, and the like.

The brake control unit 82 includes, for example, a brake ECU that controls the brake system, an actuator that drives the brake system, and the like.

The drive control unit 83 detects and controls a state of a drive system of the vehicle 1. The drive system includes, for example, a drive-force generating device for generating a drive force, such as an accelerator sensor, an internal combustion engine, or a drive motor, a drive-force transmission mechanism for transmitting a drive force to wheels, and the like.

The drive control unit 83 includes, for example, a drive ECU that controls the drive system, an actuator that drives the drive system, and the like.

The body system control unit 84 detects and controls a state of a body system of the vehicle 1. The body system includes, for example, a keyless entry system, a smart key system, a power window apparatus, a power seat, an air conditioner, an airbag, a seat belt, and a shift lever.

The body system control unit 84 includes, for example, a body system ECU that controls the body system, and an actuator that drives the body system.

The light control unit 85 detects and controls states of various lights of the vehicle 1. As a light to be controlled, for example, a headlight, a backlight, a fog light, a turn signal, a brake light, a projection, and a display of a bumper are assumed.

The light control unit 85 includes a light ECU that controls the light, an actuator that drives the light, or the like.

The horn control unit 86 detects and controls a state of a car horn of the vehicle 1. The horn control unit 86 includes, for example, a horn ECU that controls the car horn, and an actuator that drives the car horn.

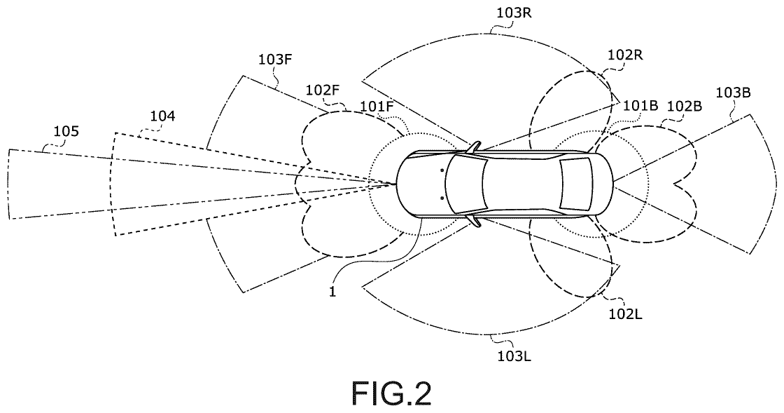

FIG. 2 is a view showing an example of sensing regions of the camera 51, the radar apparatus 52, the LiDAR 53, the ultrasonic sensor 54, and the like of the external recognition sensor 25 of FIG. 1. Note that FIG. 2 schematically shows a state of the vehicle 1 viewed from the upper surface, in which the left end side is a front end (front) side of the vehicle 1, and the right end side is a rear end (rear) side of the vehicle 1.

A sensing region 101F and a sensing region 101B represent exemplary sensing regions of the ultrasonic sensor 54.

The sensing region 101F covers the periphery of the front end of the vehicle 1 by a plurality of ultrasonic sensors 54. The sensing region 101B covers the periphery of the rear end of the vehicle 1 by the plurality of ultrasonic sensors 54.

Sensing results in the sensing region 101F and the sensing region 101B are used, for example, for parking assistance of the vehicle 1.

A sensing region 102F to a sensing region 102B represent exemplary sensing regions of the radar apparatus 52 for short distance or medium distance.

The sensing region 102F covers a position farther than the sensing region 101F in front of the vehicle 1. The sensing region 102B covers a position farther than the sensing region 101B in the rear of the vehicle 1.

A sensing region 102L covers a rear periphery of a left side surface of the vehicle 1. A sensing region 102R covers a rear periphery of a right side surface of the vehicle 1.

A sensing result in the sensing region 102F is used, for example, to detect a vehicle, a pedestrian, or the like located in front of the vehicle 1. A sensing result in the sensing region 102B is used, for example, for a function of preventing collision in the rear of the vehicle 1. Sensing results in the sensing region 102L and the sensing region 102R are used, for example, to detect an object at a blind spot on the side of the vehicle 1.

A sensing region 103F to a sensing region 103B represent exemplary sensing regions of the camera 51.

The sensing region 103F covers a position farther than the sensing region 102F in front of the vehicle 1. The sensing region 103B covers a position farther than the sensing region 102B in the rear of the vehicle 1.

A sensing region 103L covers the periphery of a left side surface of the vehicle 1. A sensing region 103R covers the periphery of a right side surface of the vehicle 1.

A sensing result in the sensing region 103F can be used in, for example, recognition of a traffic light or a traffic sign, a lane departure prevention support system, and an automated headlight control system. A sensing result in the sensing region 103B can be used in, for example, parking assistance and a surround view system.

Sensing results in the sensing region 103L and the sensing region 103R can be used, for example, in a surround view system.

A sensing region 104 represents an example of a sensing region of the LiDAR 53.

The sensing region 104 covers a position farther than the sensing region 103F in front of the vehicle 1. Meanwhile, the sensing region 104 has a narrower range in a right-left direction than that of the sensing region 103F.

A sensing result in the sensing region 104 is used, for example, to detect an object such as a surrounding vehicle.

A sensing region 105 represents an example of a sensing region of the radar apparatus 52 for long distance.

The sensing region 105 covers a position farther than the sensing region 104 in front of the vehicle 1. Meanwhile, the sensing region 105 has a narrower range in a right-left direction than that of the sensing region 104.

A sensing result in the sensing region 105 is used, for example, in adaptive cruise control (ACC), emergency brake, or collision avoidance.

Note that the sensing regions of the respective sensors of the camera 51, the radar apparatus 52, the LiDAR 53, and the ultrasonic sensor 54 included in the external recognition sensor 25 may have various configurations other than that shown in FIG. 2. Specifically, the ultrasonic sensor 54 may perform sensing on a side of the vehicle 1, and the LiDAR 53 may perform sensing on the rear side of the vehicle 1. Further, a position at which each sensor is installed is not limited to the examples described above. Further, the number of each sensor may be one or more.

### Configuration of Radar Apparatus

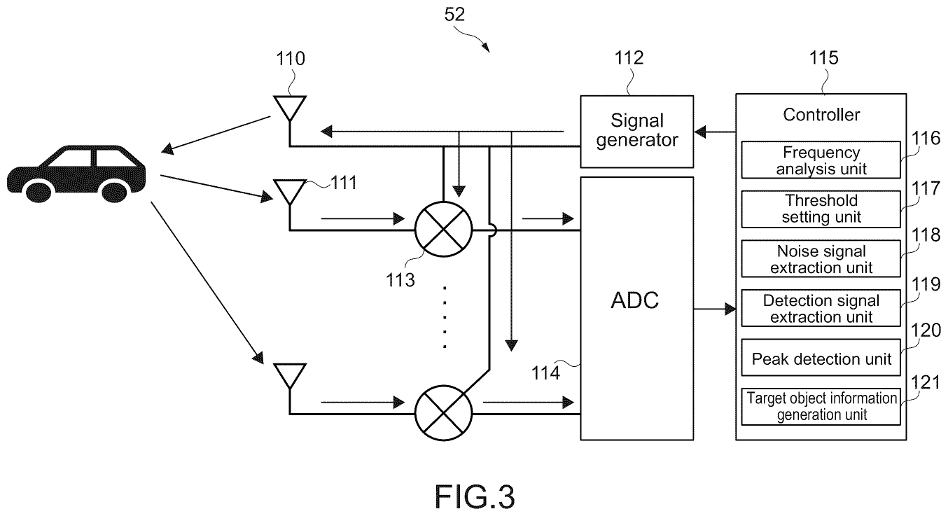

The radar apparatus 52 will be described in detail. In this embodiment, a radar apparatus of a frequency modulated continuous wave (FMCW) method will be described as an example. FIG. 3 is a schematic view showing a configuration example of the radar apparatus 52.

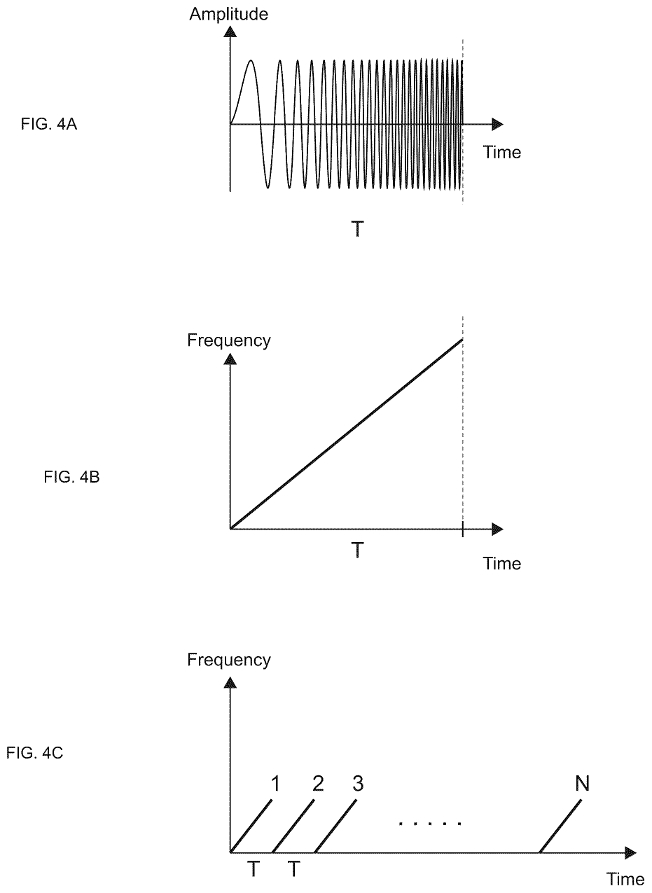

FIG. 4 is a schematic view for describing radar waves transmitted from a transmission antenna.

The radar apparatus 52 includes a transmission antenna 110, a plurality of reception antennas 111, a signal generator 112, a plurality of mixers 113, an AD converter 114, and a controller 115.

The transmission antenna 110 emits a radar wave (transmission wave) on the basis of a transmission signal generated by the signal generator 112.

In this embodiment, the signal generator 112 generates, as a transmission signal, a frequency modulated continuous wave (FMCW) signal obtained by frequency-modulating a continuous wave. The FMCW-modulated radar wave is then emitted from the transmission antenna 110.

Specifically, as shown in A and B of FIG. 4, a radar wave having a monotonically increasing frequency is emitted at a modulation time T. Such a radar wave will also be referred to as a chirp.

Further, in this embodiment, as shown in C of FIG. 4, N radar waves are continuously transmitted at intervals of the modulation time T. A chirp frame including a set of those N radar waves is transmitted from the transmission antenna 110. As the radar wave, for example, a radar wave whose frequency changes in a frequency band of 76 to 77 GHz can be used by a millimeter wave radar having a wavelength of 4 mm. The present technology is not limited to the above. A wavelength, a start frequency, a frequency band, an amplitude, a modulation time, a frequency increase rate, and the like of the radar wave are not limited and may be discretionally set.

Further, the specific configuration of the transmission antenna 110 is not limited, and any configuration may be adopted.

The plurality of reception antennas 111 is arranged in a line in the horizontal direction. Each reception antenna 111 receives a reflected wave generated by reflection of the radar wave on a target object and outputs a reception signal.

As shown in FIG. 4, the mixers 113 are disposed one by one to correspond to the respective reception antennas 111. Thus, the reception antenna 111 outputs the reception signal, which is obtained by receiving the reflected wave, to the mixer 113 disposed for the reception antenna 111 itself.

The specific configuration of the reception antenna 111 is not limited, and any configuration may be adopted.

The signal generator 112 generates a transmission signal (FMCW signal) for emitting the FMCW-modulated radar wave, and outputs the transmission signal to the transmission antenna 110. Further, the signal generator 112 outputs the generated transmission signal to each of the plurality of mixers 113.

The specific configuration of the signal generator 112 is not limited, and any configuration may be adopted.

Each of the plurality of mixers 113 mixes the transmission signal output from the signal generator 112 and the reception signal output from the reception antenna 111 to generate a beat signal (frequency difference signal) having a frequency component that is a difference in frequency between the transmission signal and the reception signal.

In other words, each of the plurality of mixers 113 generates a beat signal on the basis of the reception signal and the transmitted signal. The beat signal will also be referred to as an intermediate frequency (IF) signal.

Each of the plurality of mixers 113 outputs the generated beat signal to the AD converter 114.

The specific configuration of the mixer 113 is not limited, and any configuration may be adopted.

The AD converter 114 performs sampling of the beat signals of analog data, which are output from the respective mixers 113, and converts the beat signals into beat signals of digital data. The beat signals of digital data are output to the controller 115.

The specific configuration of the AD converter 114 is not limited, and any configuration may be adopted.

As shown in C of FIG. 4, in this embodiment, a set of N radar waves (chirp frame) at the intervals of the modulation time T is transmitted by the transmission antenna 110.

The beat signals of digital data are generated to correspond to the respective radar waves in the chirp frame. Thus, N beat signals of digital data are sequentially output to the controller 115.

If the plurality of reception antennas 111 is set as a plurality of channels, N beat signals of digital data are generated in the respective channels in response to the transmission of the chirp frame, and are output to the controller 115.

The controller 115 controls an operation of each block included in the radar apparatus 52. The controller 115 includes a hardware circuit necessary for a computer, such as a CPU and a memory (RAM and ROM). The CPU executes a program according to the present technology, which is stored in the memory, so that various types of processing are executed.

For example, a programmable logic device (PLD) such as a field-programmable gate array (FPGA) or another device such as an application-specific integrated circuit (ASIC) may be used as the controller 115.

In this embodiment, the CPU of the controller 115 executes a program according to the present technology, so that a frequency analysis unit 116, a threshold setting unit 117, a noise signal extraction unit 118, a detection signal extraction unit 119, a peak detection unit 120, and a target object information generation unit 121 are implemented as functional blocks.

A signal processing method according to this embodiment is executed by those functional blocks. Note that, in order to implement each functional block, dedicated hardware such as an integrated circuit (IC) may be used as appropriate.

The program is installed in the radar apparatus 52, for example, through a recording medium. Alternatively, the program may be installed in the radar apparatus 52 via a global network or the like. In addition, any non-transitory computer-readable storage medium may be used.

### Signal Processing Method

A signal processing method executed by the radar apparatus 52 will be described. In this embodiment, the controller 115 performs a signal processing method, which will be described below, on the beat signal of digital data.

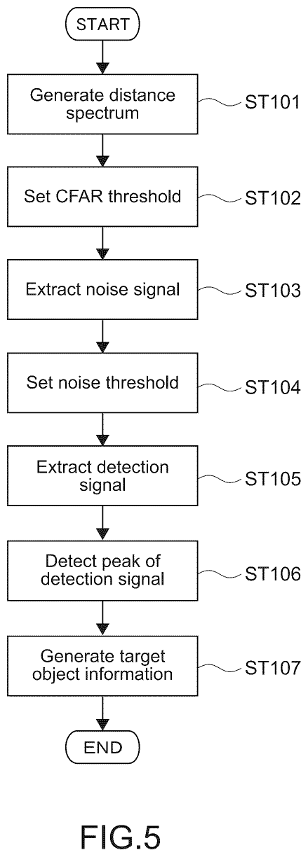

FIG. 5 is a flowchart showing an example of the signal processing method.

The frequency analysis unit 116 performs Fourier transform in a distance direction on the beat signal and generates a frequency spectrum related to a distance (hereinafter, referred to as a distance spectrum) (Step 101).

As Fourier transform, fast Fourier transform (FFT) is performed. Note that the method of generating the distance spectrum is not limited to the Fourier transform. For example, the distance spectrum may be calculated using processing such as compression sensing.

Further, the spectrum will also be referred to as spectrum.

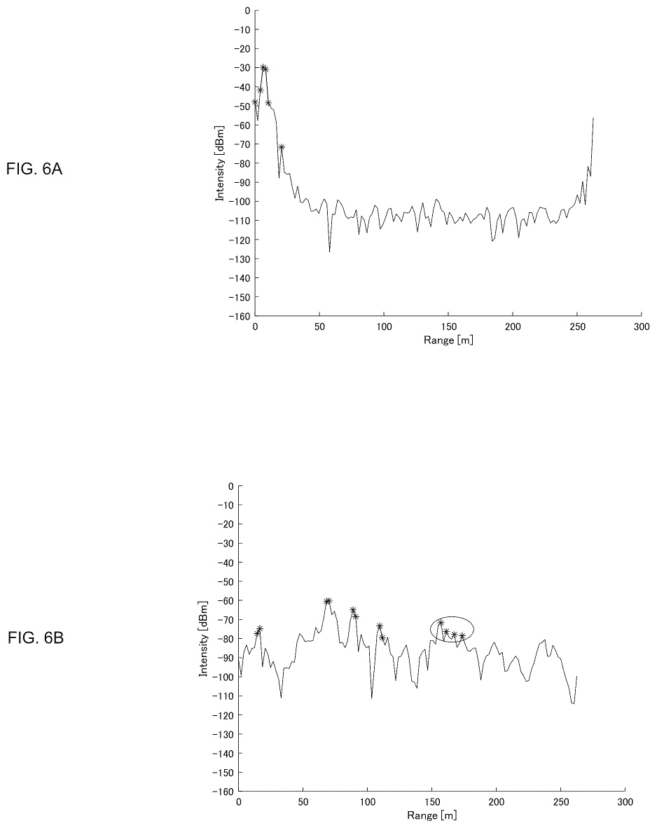

FIG. 6 is a graph showing examples of the distance spectrum obtained when measurement is performed by the radar apparatus 52 in a state in which a surrounding environment is known. In other words, FIG. 6 shows distance spectra obtained by actual measurement performed in an environment in which another vehicle or a building exists as a target object in the surroundings. Note that the horizontal axis is converted into a distance (Range (m)) corresponding to the frequency component.

A and B of FIG. 6 respectively show results of the distance and signal intensity that are measured in different surrounding environments.

In A and B of FIG. 6, a peak with a mark in which two cross marks overlap with each other with a shift of an angle of 45 degrees (hereinafter, simply referred to as cross mark) is a peak generated due to a target object (target) that exists in the surroundings.

In a region surrounded by an elliptical frame in B of FIG. 6, four peaks with the cross marks are generated in series. Those peaks are generated to correspond to buildings with length (width). For example, when a guardrail or the like exists, a plurality of peaks is generated in series.

The threshold setting unit 117 performs constant false alarm rate (CFAR) processing on the distance spectrum and sets a CFAR threshold (Step 102).

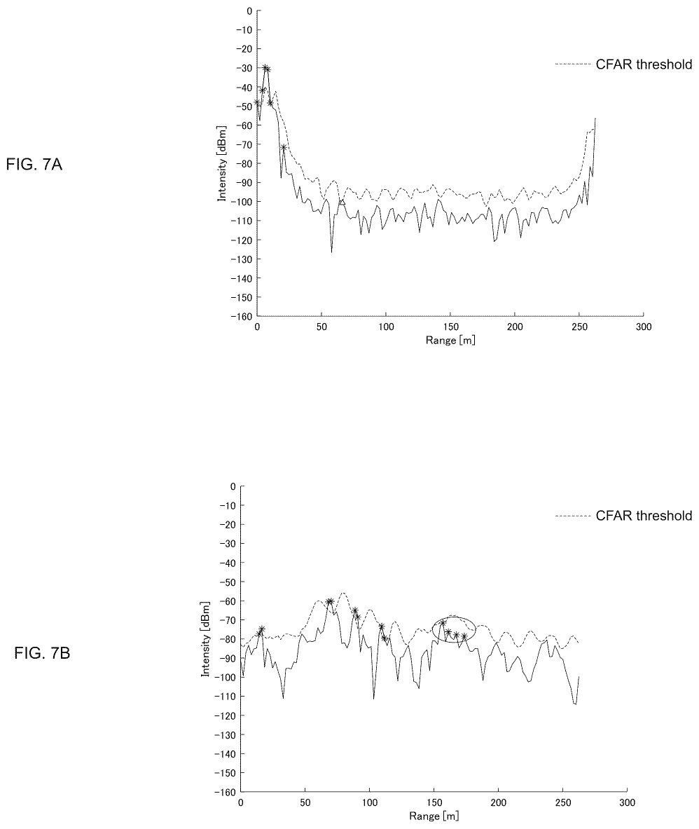

FIG. 7 is a graph showing CFAR thresholds that are set for the distance spectra shown in A and B of FIG. 6.

A specific algorithm of the CFAR processing is not limited. For example, any CFAR processing such as Greatest Of (GO) CFAR processing or Cell Averaging (CA) CFAR processing may be executed.

The noise signal extraction unit 118 extracts a noise signal from signals smaller than the CFAR threshold in the distance spectrum (Step 103).

For example, all of the signals smaller than the CFAR threshold in the distance spectrum, or some of the signals smaller than the CFAR threshold in the distance spectrum are extracted as noise signals.

For example, a signal included in a predetermined range among the signals smaller than the CFAR threshold may be extracted as a noise signal.

As the predetermined range, for example, a range related to the signal intensity (Intensity) is defined. For example, a signal included in a range from a first signal intensity to a second signal intensity larger than the first signal intensity is extracted as a noise signal. Any value may be set for the first signal intensity and the second signal intensity.

Alternatively, a signal in which a difference in signal intensity from the CFAR threshold is larger than a predetermined threshold may be extracted as a noise signal. In other words, a signal smaller than a value obtained by subtracting the predetermined threshold from the CFAR threshold may be extracted as a noise signal. Note that the predetermined threshold may be discretionally set.

Conversely, a signal in which a difference in signal intensity from the CFAR threshold is smaller than a predetermined threshold may be extracted as a noise signal. In other words, a signal larger than a value obtained by subtracting the predetermined threshold from the CFAR threshold may be extracted as a noise signal. Note that the predetermined threshold may be discretionally set.

As the predetermined range, for example, a range in the distance (Range) may be defined. For example, a signal included in a range from a first distance to a second distance larger than the first distance is extracted as a noise signal. Any value may be set for the first distance and the second distance.

Alternatively, a signal of a distance that is larger than a predetermined threshold may be extracted as a noise signal. Conversely, a signal of a distance that is smaller than the predetermined threshold may be extracted as a noise signal. Note that the predetermined threshold may be discretionally set.

The threshold setting unit 117 sets a noise threshold on the basis of the noise signal (Step 104).

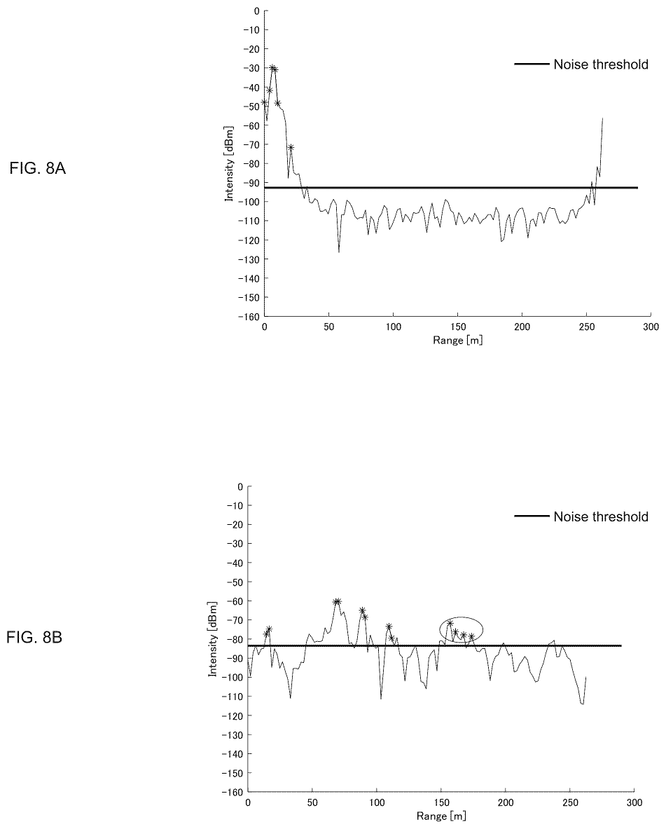

FIG. 8 is a graph showing noise thresholds that are set for the distance spectra shown in A and B of FIG. 6. As shown in A and B of FIG. 8, a predetermined signal intensity is set as the noise threshold.

In this embodiment, a noise floor is calculated on the basis of the noise signal, and a value larger than the calculated noise floor is set as the noise threshold.

As the noise floor, for example, an average value, a variance value, or a standard deviation of the noise signal is used. In addition, any statistical processing such as a minimum value, a maximum value, a mode (mode value), or a median (median value) may be performed on the noise signal, and a result thereof may be calculated as the noise floor.

For the noise threshold, for example, a value obtained by multiplying the noise floor by a predetermined coefficient or a value obtained by adding a predetermined constant to the noise floor is used. As a matter of course, the present technology is not limited to the above, and a value larger than the noise floor may be set as appropriate.

For example, the noise threshold may be set by multiplying the noise floor by a value of 1.0 to 2.0 as a predetermined coefficient. Further, the noise threshold may be set by adding 0.0 to 20 dB as a predetermined constant to the noise floor.

Note that, as will be described later, in the present disclosure, expressions using the term “than” such as “larger than A” and “smaller than A” are expressions that comprehensively include concepts that include the case of being equal to A and concepts that do not include the case of being equal to A. For example, “larger than A” is not limited to the case where it does not include “equal to A”; however, it also includes “equal to or larger than A”. Therefore, the same value as that of the noise floor may be used as the noise threshold.

Further, the noise threshold may be directly calculated from the noise signal without calculating the noise floor. For example, the noise threshold may be calculated on the basis of an average value, a variance value, or a standard deviation of the noise signal.

The detection signal extraction unit 119 extracts, as a detection signal, a signal larger than the noise threshold in the distance spectrum (Step 105). In the distance spectra shown in A and B of FIG. 8, a signal larger than the noise threshold is extracted as a detection signal.

The peak detection unit 120 detects a peak of the detection signal (Step 106).

The target object information generation unit 121 generates target object information related to a target object existing in the surroundings (Step 107).

In this embodiment, the target object information generation unit 121 detects a target object existing in the surroundings on the basis of a result of the detection by the peak detection unit 120. Further, a distance to the target object is detected.

As the target object information, a relative speed, an angle (azimuth), and the like related to the target object existing in the surroundings may be generated. All of those pieces of information may be generated, or at least one piece of information may be generated.

For example, the distance spectrum shown in FIG. 6 or the like is generated for each of the N beat signals corresponding to the chirp frame. Therefore, N distance spectra are generated to correspond to the transmission of the chirp frame.

Data related to a single distance of the N distance spectra is subjected to Fourier transform in a relative speed direction to generate a frequency spectrum related to a relative speed (hereinafter, referred to as a relative speed spectrum). The relative speed of the target object can be detected in accordance with a peak frequency of the relative speed spectrum. Note that the method of generating the relative speed spectrum is not limited to the Fourier transform. For example, the relative speed spectrum may be calculated using processing such as compression sensing.

Further, data related to a single distance and speed of the relative speed spectrum calculated in each of a plurality of reception antennas (a plurality of channels) is subjected to Fourier transform in an angular direction to generate a frequency spectrum related to an angle (hereinafter, referred to as an angular spectrum). The angle of the target object can be detected in accordance with a peak frequency of the angular spectrum. Note that the method of generating the angular spectrum is not limited to the Fourier transform. For example, a high-resolution algorithm such as Capon or MUSIC may be used.

As described above, it is possible to detect the relative speed and the angle of the target object on the basis of the distance spectrum. Further, it is also possible to detect the relative speed and the angle of the target object by using the detection signal that is larger than the noise threshold in the distance spectrum.

The target object information generated by the target object information generation unit 121 is output, as sensing data (sensing result), to each block such as the travel assistance and automated driving control unit 29 shown in FIG. 1.

In this embodiment, the distance spectrum exemplified in FIG. 6 or the like is an embodiment of a frequency spectrum generated on the basis of a reception signal obtained by receiving a reflected wave obtained by reflection of a radar wave.

The CFAR threshold is an embodiment of a first threshold according to the present technology.

The noise threshold is an embodiment of a second threshold according to the present technology.

Further, the threshold setting unit 117 and the noise signal extraction unit 118 implement a first extraction unit that sets a first threshold by performing CFAR processing on the frequency spectrum and extracts a noise signal from signals smaller than the first threshold in the frequency spectrum.

Further, the threshold setting unit 117 and the detection signal extraction unit 119 implement a second extraction unit that sets a second threshold on the basis of the noise signal and extracts, as a detection signal, a signal larger than the second threshold in the frequency spectrum.

Further, the transmission antenna 110, the plurality of reception antennas 111, the signal generator 112, the plurality of mixers 113, and the AD converter 114 implement a transmission and reception unit that emits a radar wave by using a FMCW signal as a transmission signal and generates a beat signal on the basis of the reception signal and the transmission signal.

Further, the peak detection unit 120 is an embodiment of a peak detection unit according to the present technology.

Further, the target object information generation unit 121 is an embodiment of a target object information generation unit according to the present technology. The target object information generation unit 121 is also referred to as a target object extraction unit.

### Description of Effects of Present Technology

The CFAR processing is performed on the distance spectrum to set a CFAR threshold. A technique is also conceivable, in which peak processing is performed on a signal larger than the CFAR threshold, to detect a distance to a target object.

For example, it is assumed that peak detection is performed on a signal larger than the CFAR threshold shown in A and B of FIG. 7, and a distance to the target object is calculated.

In this case, as can be seen when the graphs of FIG. 6 and FIG. 7 are compared, there may be a case where a peak with a cross mark, that is, a peak generated due to the presence of an actual target object falls below the CFAR threshold and is not detected.

In the examples shown in A of FIG. 6 and A of FIG. 7, the sixth peak from the left is smaller than the CFAR threshold and omitted from detection. This is probably due to the fact that the CFAR threshold is pulled by the strong peak, i.e., the fifth peak from the left.

In other words, in the peak detection using the CFAR threshold, there is a problem that the threshold is pulled by a strong peak, and it is difficult to detect a weak peak immediately after a strong peak.

In the examples shown in B of FIG. 6 and B of FIG. 7, four peaks in a continuous state generated by buildings, guardrails, and the like having length (width) are smaller than the CFAR threshold and are omitted from detection.

In other words, in the peak detection using the CFAR threshold, it is also difficult to detect peaks in a continuous state generated by buildings, guardrails, and the like having length (width).

In such a manner, in the peak detection using the CFAR threshold, there is a possibility that a target object existing in the surroundings is missed.

Further, there is also a possibility that noise may be erroneously detected in the peak detection using the CFAR threshold. For example, in the examples of A of FIG. 6 and A of FIG. 7, a peak with a triangular mark exceeds the CFAR threshold and is detected, though the peak is noise.

This is probably due to the fact that the threshold is pulled by a very weak noise, and noise immediately after that noise becomes larger than the CFAR threshold.

In such a manner, in a region where only noise is generated, noise may be detected as a signal larger than the CFAR threshold depending on the intensity of the noise.

The present technology has a main feature in which the CFAR threshold obtained by the CFAR processing is used to extract a noise signal and to detect a noise floor. In other words, the CFAR threshold is used to separate a peak generated by the presence of a target object in the distance spectrum from noise.

For example, a target object extraction rate (number of data equal to or larger than CFAR threshold/all bins) by the peak detection using the CFAR threshold is at most approximately 1%, and the remaining 99% is likely to be almost noise.

Therefore, if the remaining 99% of data is regarded as noise, and statistical processing such as averaging is performed, it is conceivable that a noise floor can be detected.

The noise threshold is set on the basis of the noise signal (noise floor), and a signal larger than the noise threshold is extracted as a detection signal. The detection signal is subjected to peak detection, so that it is possible to sufficiently suppress a possibility of missing a target object existing in the surroundings. In other words, it is possible to sufficiently improve detection accuracy of a target object existing in the surroundings. Further, it is possible to remove noise with high accuracy.

As shown in FIG. 8, the detection signal larger than the noise threshold is subjected to peak detection, so that it is possible to accurately detect the peaks with cross mark shown in FIG. 6. Further, the peak with the triangular mark, i.e., noise, shown in A of FIG. 7 is also prevented from being detected.

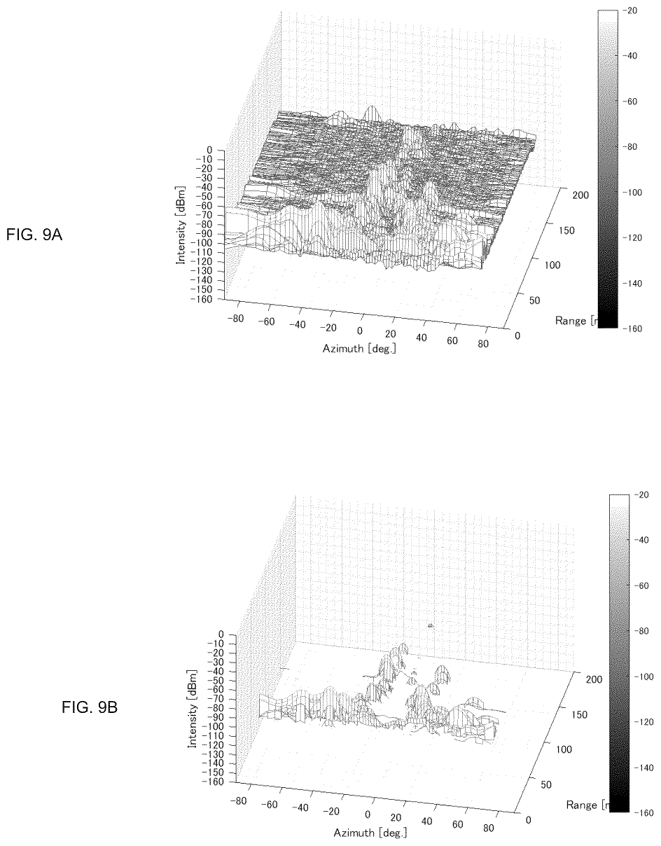

FIG. 9 is a graph showing exemplary distance spectra corresponding to an azimuth angle (Azimuth).

In A of FIG. 9, all the signals in the distance spectrum for each azimuth angle are used. In B of FIG. 9, a detection signal larger than the noise threshold is extracted.

If the present technology is applied, it is possible to separate the peak generated by the presence of a target object from noise with high accuracy, and to improve detection accuracy of the target object. Further, it is possible to sufficiently suppress erroneous detection of noise.

For example, it is possible to detect a weak peak immediately after a strong peak together. This makes it possible to, for example, separate and accurately detect target objects having a large difference in intensity, such as a vehicle, and a pedestrian, a bicycle, or the like immediately behind the vehicle.

Further, if the present technology is applied, it is possible to accurately detect a plurality of peaks generated in a continuous state. This makes it possible to, for example, detect buildings, guardrails, or the like having length (width) with high accuracy.

### Improvement in Detection Accuracy of Noise Floor

When the noise floor is detected on the basis of the noise signal, it is possible to improve the detection accuracy of the noise floor by excluding the influence of scattering from a stationary object such as a road surface. For example, the noise floor may be larger than an actual value due to the influence of multipath reflections from the stationary object.

For example, the noise signal extraction unit 118 extracts, as a noise signal, a signal other than a signal corresponding to a reflected wave from the stationary object among the signals smaller than the CFAR threshold. Use of the noise signal makes it possible to detect the noise floor with high accuracy.

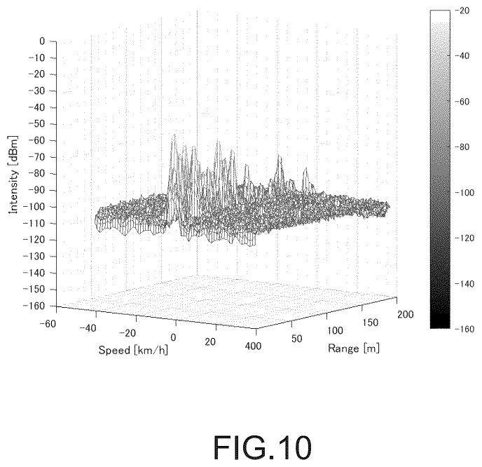

FIG. 10 is a graph showing an exemplary two-dimensional spectrum having two axes of a distance (Range) and a relative speed (Speed).

The two-dimensional spectrum shown in FIG. 10 includes a distance spectrum and a relative speed spectrum generated by performing Fourier transform on the distance spectrum in the relative speed direction.

The noise signal extraction unit 118 acquires an own-vehicle speed. The own-vehicle speed can be acquired from, for example, the vehicle control ECU 21 shown in FIG. 1.

A target object having a relative speed of (−own-vehicle speed) with respect to the own vehicle can be regarded as a stationary object. Therefore, a signal of the bin of the stationary object (=bin of−own-vehicle speed) of the relative speed spectrum is removed. The signal of the bin of the stationary object (=bin of−own-vehicle speed) corresponds to a signal corresponding to a reflected wave from the stationary object.

The noise signal extraction unit 118 extracts, as a noise signal, a signal other than the signal of the bin of the stationary object (=bin of−own-vehicle speed) of the relative speed spectrum among the signals smaller than the CFAR threshold. On the basis of the noise signal, the noise floor can be detected with high accuracy.

Since a highly accurate noise floor is detected, the accuracy of the noise threshold is also improved. As a result, it is possible to accurately detect a target object existing in the surroundings on the basis of the detection signal larger than the noise threshold.

Note that not only the signal of the bin of the stationary object in the relative speed spectrum but also a signal in the vicinity of the bin of the stationary object may be removed. For example, a signal of a bin in the range of +/−10% in the vicinity of the bin of the stationary object may be removed. As a matter of course, the range (+%) in the vicinity may be discretionally set.

As described above, the noise signal may be extracted on the basis of the own-vehicle speed and the relative speed spectrum. Note that, in this embodiment, the vehicle 1 on which the radar apparatus 52 is mounted is an embodiment of a mobile object. Further, the own-vehicle speed corresponds to a speed of the mobile object.

As described above, in the radar apparatus 52 according to this embodiment, the CFAR processing is performed on the distance spectrum to set the CFAR threshold, and the noise signal is extracted from the signals smaller than the CFAR threshold in the distance spectrum.

Further, the noise threshold is set on the basis of the noise signal, and a signal larger than the noise threshold in the distance spectrum is extracted as the detection signal.

The peak of the detection signal is detected, which makes it possible to improve the detection accuracy of a target object.

Applying the present technology makes it possible to sufficiently prevent erroneous detection and detection omission in target object detection using a radar.

### OTHER EMBODIMENTS

The present technology is not limited to the embodiment described above and can implement various other embodiments.

In the above description, the setting of a first threshold (CFAR threshold), the extraction of a noise signal (detection of noise floor), the setting of a second threshold (noise threshold), the extraction of a detection signal, and peak detection are performed on the distance spectrum.

The present technology is not limited to the above. The setting of a first threshold (CFAR threshold), the extraction of a noise signal (detection of noise floor), the setting of a second threshold (noise threshold), the extraction of a detection signal, and peak detection may be performed on the relative speed spectrum or the angular spectrum.

In other words, the first extraction unit may acquire the relative speed spectrum or the angular spectrum as a frequency spectrum generated on the basis of a reception signal obtained by receiving a reflected wave obtained by reflection of a radar wave.

The present technology is also applicable to a radar apparatus of a method other than the FMCW method.

The signal processing method and the program according to the present technology may be executed, and the controller of the radar apparatus according to the present technology may be provided, by linking a plurality of computers communicably connected via a network or the like.

In other words, the signal processing method and the program according to the present technology can be performed not only in a computer system including a single computer, but also in a computer system in which a plurality of computers operates cooperatively.

Note that, in the present disclosure, the system refers to a set of components (such as apparatuses and modules (parts)) and it does not matter whether all of the components are in a single housing. Thus, a plurality of apparatuses accommodated in separate housings and connected to each other through a network, and a single apparatus in which a plurality of modules is accommodated in a single housing are both the system.

Execution of the signal processing method and the program according to the present technology by the computer system includes, for example, both a case in which the setting of a first threshold, the extraction of a noise signal, the detection of a noise floor, the setting of a second threshold, the extraction of a detection signal, the peak detection, and the like are performed by a single computer; and a case in which the respective processes are performed by different computers. Further, the execution of each process by a predetermined computer includes causing another computer to perform part or all of the processes and obtaining a result thereof.

In other words, the information processing method and the program according to the present technology are also applicable to a configuration of cloud computing in which a single function is shared and cooperatively processed by a plurality of apparatuses through a network.

The configurations of the vehicle control system and the radar apparatus described with reference to the respective figures; and the processing flows thereof; and the like are merely embodiments, and any modifications may be discretionally made thereto without departing from the spirit of the present technology. In other words, any other configurations or algorithms for the purpose of practicing the present technology may be adopted.

In the present disclosure, to easily understand the description, the words such as “substantially”, “approximately”, and “about” are appropriately used. Meanwhile, it does not define a clear difference between the case where those words such as “substantially”, “approximately”, and “about” are used and the case where those words are not used.

In other words, in the present disclosure, concepts defining shapes, sizes, positional relationships, states, and the like, such as “central”, “middle”, “uniform”, “equal”, “same”, “orthogonal”, “parallel”, “symmetric”, “extended”, “axial”, “columnar”, “cylindrical”, “ring-shaped”, and “annular”, are concepts including “substantially central”, “substantially middle”, “substantially uniform”, “substantially equal”, “substantially the same”, “substantially orthogonal”, “substantially parallel”, “substantially symmetric”, “substantially extended”, “substantially axial”, “substantially columnar”, “substantially cylindrical”, “substantially ring-shaped”, “substantially annular”, and the like.

For example, the states included in a predetermined range (e.g., range of +10%) with reference to “completely central”, “completely middle”, “completely uniform”, “completely equal”, “completely the same”, “completely orthogonal”, “completely parallel”, “completely symmetric”, “completely extended”, “completely axial”, “completely columnar”, “completely cylindrical”, “completely ring-shaped”, “completely annular”, and the like are also included.

Therefore, even if the words such as “substantially”, “approximately”, and “about” are not added, the concept that may be expressed by adding so-called “substantially”, “approximately”, and “about” thereto can be included. To the contrary, the complete states are not necessarily excluded from the states expressed by adding “substantially”, “approximately”, “about”, and the like.

In the present disclosure, expressions using the term “than” such as “larger than A” and “smaller than A” are expressions that comprehensively include concepts that include the case of being equal to A and concepts that do not include the case of being equal to A. For example, “larger than A” is not limited to the case where it does not include “equal to A”; however, it also includes “equal to or larger than A”. Further, “smaller than A” is not limited to “less than A”; it also includes “equal to or smaller than A”.

Upon implementation of the present technology, specific settings and other settings may be appropriately adopted from the concepts that are included in “larger than A” and “smaller than A” to achieve the effects described above.

At least two of the features among the features described above according to the present technology can also be combined. In other words, various features described in the respective embodiments may be combined discretionarily regardless of the embodiments. Further, the various effects described above are merely illustrative and not restrictive, and other effects may be exerted.

Note that the present technology may also take the following configurations.
(1) A radar apparatus, including:
   a first extraction unit that sets a first threshold by performing constant false alarm rate (CFAR) processing on a frequency spectrum, the frequency spectrum being generated on the basis of a reception signal obtained by receiving a reflected wave obtained by reflection of a radar wave, and extracts a noise signal from signals smaller than the first threshold in the frequency spectrum;
   a second extraction unit that sets a second threshold on the basis of the noise signal and extracts, as a detection signal, a signal larger than the second threshold in the frequency spectrum; and
   a peak detection unit that detects a peak of the detection signal.
(2) The radar apparatus according to (1), in which
   the first extraction unit extracts, as the noise signal, a signal smaller than the first threshold or some signals of the signals smaller than the first threshold.
(3) The radar apparatus according to (1) or (2), in which
   the first extraction unit extracts, as the noise signal, a signal included in a predetermined range among the signals smaller than the first threshold.
(4) The radar apparatus according to (1) or (2), in which
   the first extraction unit extracts, as the noise signal, a signal other than a signal corresponding to a reflected wave from a stationary object among the signals smaller than the first threshold.
(5) The radar apparatus according to any one of (1) to (4), in which
   the second extraction unit calculates a noise floor on the basis of the noise signal and sets, as the second threshold, a value larger than the calculated noise floor.
(6) The radar apparatus according to (5), in which
   the second extraction unit calculates, as the noise floor, an average value, a variance value, or a standard deviation of the noise signal.
(7) The radar apparatus according to (5) or (6), in which
   the second extraction unit sets, as the second threshold, a value obtained by multiplying the noise floor by a predetermined coefficient or a value obtained by adding a predetermined constant to the noise floor.
(8) The radar apparatus according to any one of (1) to (7), further including
   a transmission and reception unit that emits the radar wave by using a frequency modulated continuous wave (FMCW) signal obtained by frequency-modulating a continuous wave as a transmission signal, and generates a beat signal on the basis of the reception signal and the transmission signal, in which
   the first extraction unit acquires, as the frequency spectrum, a frequency spectrum related to a distance that is generated by performing Fourier transform in a distance direction on the beat signal.
(9) The radar apparatus according to any one of (1) to (8), further including
   a target object information generation unit that detects a target object existing in a vicinity on the basis of a result of the detection by the peak detection unit.
(10) The radar apparatus according to (8) or (9), in which
   the radar apparatus is configured to be mounted on a mobile object, and
   the first extraction unit extracts, as the noise signal, a signal other than a signal corresponding to a reflected wave from a stationary object among the signals smaller than the first threshold, on the basis of a speed of the mobile object and a frequency spectrum related to a relative speed that is generated by performing Fourier transform in a relative speed direction on the frequency spectrum related to the distance.
(11) The radar apparatus according to any one of (1) to (7), further including
   a transmission and reception unit that emits the radar wave by using a frequency modulated continuous wave (FMCW) signal obtained by frequency-modulating a continuous wave as a transmission signal, and generates a beat signal on the basis of the reception signal and the transmission signal, in which
   the first extraction unit acquires, as the frequency spectrum, a frequency spectrum related to a relative speed that is generated by performing Fourier transform in a relative speed direction on a frequency spectrum related to a distance that is generated by performing Fourier transform in a distance direction on the beat signal.
(12) A signal processing method executed by a computer system, the method including:
   setting a first threshold by performing constant false alarm rate (CFAR) processing on a frequency spectrum, the frequency spectrum being generated on the basis of a reception signal obtained by receiving a reflected wave obtained by reflection of a radar wave, and extracting a noise signal from signals smaller than the first threshold in the frequency spectrum;
   setting a second threshold on the basis of the noise signal and extracting, as a detection signal, a signal larger than the second threshold in the frequency spectrum; and detecting a peak of the detection signal.
(13) A program causing a computer system to execute the steps of:
   setting a first threshold by performing constant false alarm rate (CFAR) processing on a frequency spectrum, the frequency spectrum being generated on the basis of a reception signal obtained by receiving a reflected wave obtained by reflection of a radar wave, and extracting a noise signal from signals smaller than the first threshold in the frequency spectrum;
   setting a second threshold on the basis of the noise signal and extracting, as a detection signal, a signal larger than the second threshold in the frequency spectrum; and
   detecting a peak of the detection signal.

### REFERENCE SIGNS LIST

1 vehicle
11 vehicle control system
21 vehicle control ECU
52 radar apparatus
110 transmission antenna
111 reception antenna
112 signal generator
113 mixer
114 AD converter
115 controller
116 frequency analysis unit
117 threshold setting unit
118 noise signal extraction unit
119 detection signal extraction unit
120 peak detection unit
121 target object information generation unit

1. A radar apparatus, comprising:
a first extraction unit that sets a first threshold by performing constant false alarm rate (CFAR) processing on a frequency spectrum, the frequency spectrum being generated on a basis of a reception signal obtained by receiving a reflected wave obtained by reflection of a radar wave, and extracts a noise signal from signals smaller than the first threshold in the frequency spectrum;
a second extraction unit that sets a second threshold on a basis of the noise signal and extracts, as a detection signal, a signal larger than the second threshold in the frequency spectrum; and
a peak detection unit that detects a peak of the detection signal.

2. The radar apparatus according to claim 1, wherein
the first extraction unit extracts, as the noise signal, a signal smaller than the first threshold or some signals of the signals smaller than the first threshold.

3. The radar apparatus according to claim 1, wherein
the first extraction unit extracts, as the noise signal, a signal included in a predetermined range among the signals smaller than the first threshold.

4. The radar apparatus according to claim 1, wherein
the first extraction unit extracts, as the noise signal, a signal other than a signal corresponding to a reflected wave from a stationary object among the signals smaller than the first threshold.

5. The radar apparatus according to claim 1, wherein
the second extraction unit calculates a noise floor on a basis of the noise signal and sets, as the second threshold, a value larger than the calculated noise floor.

6. The radar apparatus according to claim 5, wherein
the second extraction unit calculates, as the noise floor, an average value, a variance value, or a standard deviation of the noise signal.

7. The radar apparatus according to claim 5, wherein
the second extraction unit sets, as the second threshold, a value obtained by multiplying the noise floor by a predetermined coefficient or a value obtained by adding a predetermined constant to the noise floor.

8. The radar apparatus according to claim 1, further comprising
a transmission and reception unit that emits the radar wave by using a frequency modulated continuous wave (FMCW) signal obtained by frequency-modulating a continuous wave as a transmission signal, and generates a beat signal on a basis of the reception signal and the transmission signal, wherein
the first extraction unit acquires, as the frequency spectrum, a frequency spectrum related to a distance that is generated by performing Fourier transform in a distance direction on the beat signal.

9. The radar apparatus according to claim 1, further comprising
a target object information generation unit that detects a target object existing in a vicinity on a basis of a result of the detection by the peak detection unit.

10. The radar apparatus according to claim 8, wherein
the radar apparatus is configured to be mounted on a mobile object, and
the first extraction unit extracts, as the noise signal, a signal other than a signal corresponding to a reflected wave from a stationary object among the signals smaller than the first threshold, on a basis of a speed of the mobile object and a frequency spectrum related to a relative speed that is generated by performing Fourier transform in a relative speed direction on the frequency spectrum related to the distance.

11. The radar apparatus according to claim 1, further comprising
a transmission and reception unit that emits the radar wave by using a frequency modulated continuous wave (FMCW) signal obtained by frequency-modulating a continuous wave as a transmission signal, and generates a beat signal on a basis of the reception signal and the transmission signal, wherein
the first extraction unit acquires, as the frequency spectrum, a frequency spectrum related to a relative speed that is generated by performing Fourier transform in a relative speed direction on a frequency spectrum related to a distance that is generated by performing Fourier transform in a distance direction on the beat signal.

12. A signal processing method executed by a computer system, the method comprising:
setting a first threshold by performing constant false alarm rate (CFAR) processing on a frequency spectrum, the frequency spectrum being generated on a basis of a reception signal obtained by receiving a reflected wave obtained by reflection of a radar wave, and extracting a noise signal from signals smaller than the first threshold in the frequency spectrum;
setting a second threshold on a basis of the noise signal and extracting, as a detection signal, a signal larger than the second threshold in the frequency spectrum; and
detecting a peak of the detection signal.

13. A program causing a computer system to execute the steps of:
setting a first threshold by performing constant false alarm rate (CFAR) processing on a frequency spectrum, the frequency spectrum being generated on a basis of a reception signal obtained by receiving a reflected wave obtained by reflection of a radar wave, and extracting a noise signal from signals smaller than the first threshold in the frequency spectrum;
setting a second threshold on a basis of the noise signal and extracting, as a detection signal, a signal larger than the second threshold in the frequency spectrum; and
detecting a peak of the detection signal.
